(19) United States
(12) Patent Application Publication
(10) Pub. No.: US 2014/0139835 A1
(43) Pub. Date: May 22, 2014

(54) MEASUREMENT DEVICE OF DEGREE OF CURE

(71) Applicant: Samsung Electro-Mechanics Co., Ltd., Suwon (KR)

(72) Inventors: Ji Hoon KIM, Suwon (KR); Suk Jin Ham, Seoul (KR); Ji Hyuk Lim, Suwon (KR)

(73) Assignee: Samsung Electro-Mechanics Co., Ltd., Suwon (KR)

(21) Appl. No.: 14/060,385

(22) Filed: Oct. 22, 2013

(30) Foreign Application Priority Data
Nov. 16, 2012 (KR) 10-2012-0130180

(51) Int. Cl. G01N 21/47; G01N 21/25

(52) U.S. Cl. CPC G01N 21/47; G01N 21/25
USPC 356/402; 356/446

(57) ABSTRACT

A measurement device of a degree of cure, and more particularly, a measurement device of a degree of cure capable of using while being portable in a production line. The measurement device of the degree of cure includes: a light source; a light transmission and reflection mirror passing through a light irradiated from the light source and reflecting scattered light reflected and returned from a sample; a light splitting mirror transmitting and reflecting the scattered light so as to detect intensity of the scattered light reflected by the light transmission and reflection mirror; a detector detecting the intensity of the scattered light transmitted and reflected by the light splitting mirror; and a data obtaining unit collecting data of the intensity of the scattered light detected by the detector.

### CROSS REFERENCE(S) TO RELATED APPLICATIONS

This application claims the benefit under 35 U.S.C. Section 119 of Korean Patent Application Serial No. 10-2012-0130180, entitled “Measurement Device of Degree of Cure” filed on Nov. 16, 2012, which is hereby incorporated by reference in its entirety into this application.

### BACKGROUND OF THE INVENTION

1. Technical Field

The present invention relates to a measurement device of a degree of cure, and more particularly, to a measurement device of a degree of cure capable of rapidly and conveniently being used in a production line.

2. Description of the Related Art

In general, a measurement of a degree of cure provides very important information regarding characteristic evaluation of dielectric, polymer, or the like integrated at a high-density in an information technology (IT) industry.

The conventional measurement methods of the degree of cure are classified as a destructive inspection damaging a portion of a product to measure the degree of cure. However, a non-destructive inspection measuring the degree of cure in a state the product is not damaged. Therefore, a method of measuring the degree of cure of the product using a non-destructive method has gained higher interest and been widely used.

Currently, the non-destructive measurement equipments of the degree of cure mainly used in an industrial field are an FT-IR, a Raman spectroscope, and the like. The FT-IR basically uses an interferometer in order to form a spectrum and the Raman spectroscope forms the spectrum by using a Raman scattering. However, both equipment systems are not built only for the degree of cure measurement and not optimized for the utilization in a mass-production line in an industrial field.

### RELATED ART DOCUMENT

### Patent Document

(Patent Document 1) Cited Reference: Japanese Patent Laid-Open Publication No. 2005-233928

### SUMMARY OF THE INVENTION

An object of the present invention is to provide a measurement device of a degree of cure having excellent portability so as to effectively conduct a measurement of the degree of cure of a product.

According to an exemplary embodiment of the present invention, there is provided a measurement device of a degree of cure, including: a light source; a light propagation from the light source; transmission and reflection through/from a mirror; light irradiation onto a sample; light scattering in the sample and reflection back to the mirror; a light relection from the mirror; a detector detecting the intensity of the scattered light reflected from the dichroic mirror; a light splitting mirror that divides into two separate light; light filters that select light wavelength; and a light detecting unit measuring light intensity of the scattered light.

The light transmission and reflection mirror may be a dichroic mirror reflecting a light having a wavelength of a predetermined range and transmitting the rest of the light.

The light splitting mirror may be a beam splitter and the measurement device of the degree of cure may further include a focus lens installed bebetween the light transmission and reflection mirror and the sample.

The measurement device of the degree of cure may further include a filter installed between the light splitting mirror and the detector.

The detector may be configured of a first detector and a second detector according to a direction of the light transmitted and reflected by the light splitting mirror.

The filter may be configured of a first filter and a second filter according to a direction of the light split by the light splitting mirror.

The first filter and the second filter may each filter a light wavelength having molecular structures participating in a curing reaction of the sample and a light wavelength having molecular structures not participating in the curing reaction of the sample.

### BRIEF DESCRIPTION OF THE DRAWINGS

FIG. 1 is an illustration view showing a measurement device of a degree of cure according to an exemplary embodiment of the present invention.

### DESCRIPTION OF THE PREFERRED EMBODIMENTS

Hereinafter, an exemplary embodiment of the present invention will be described in detail with reference to the accompanying drawings.

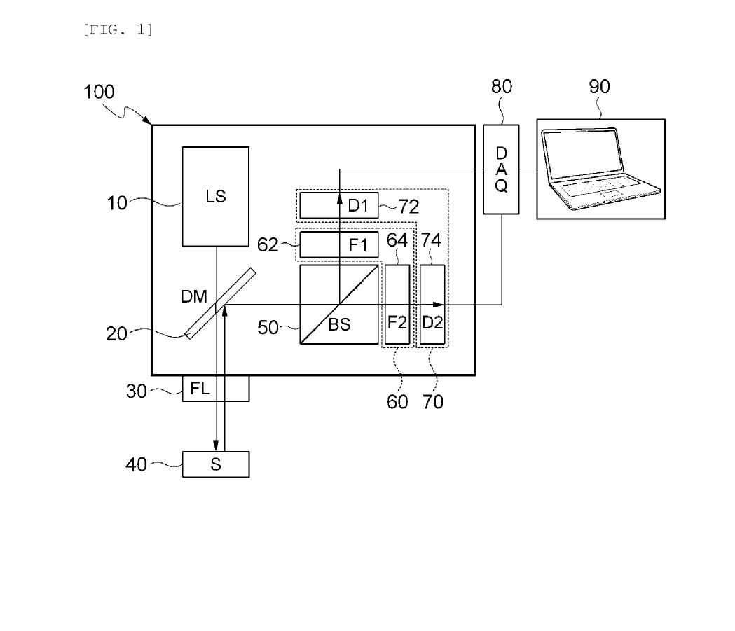

FIG. 1 is an illustration view showing a measurement device of a degree of cure according to an exemplary embodiment of the present invention.

As shown, the measurement device of the degree of cure 100 includes a light source 10, a light transmission and reflection mirror 20 transmitting and reflecting light irradiated from the light source 10, a focal lens 30 installed between the light transmission and reflection mirror 20 and a sample 40, a light splitting mirror 50 again transmitting and reflecting the light reflected from the light transmission and reflection mirror 20, a detector 70 detecting light intensity split by the light splitting mirror 50, and a data acquisition unit 80 collecting data detected by the detector.

The light source 10 may provide monochromatic light and may provide various wavelengths from ultraviolet ray to near-infrared ray according to the sample.

The light emitted from the light source 10 passes through the light transmission and reflection mirror 20 and the scattered light is reflected from a surface of the sample 40. The light transmission and reflection mirror 20, which is used to distinguish between a wavelength of the light source 10 and the light reflected from the sample 40, serves as a filter reflecting light having a wavelength of a predetermined range and transmitting the rest of the light.

Here, wavelength bands of the reflected light having the predetermined wavelengths ranging from 6.67 to 7 μm and 6.06 to 6.15 μm that contains information regarding the measurement of the degree of cure of the sample.

The above-mentioned light transmission and reflection mirror 20 may be a dichroic mirror.

The focus lens 30 may be installed between the light transmission and reflection mirror 20 and the sample 40. The focus lens 30 may be a convex lens to determine a depth of focus and one or more focus lenses 30 may be continuously disposed.

After the light emitted from the light source 10 continuously passes through the light transmission and reflection mirror 20 and the focus lens 30, it is scattered in the sample and reflected from the surface of the sample 40 and then passes through the focus lens 30 again. The light passed through the focus lens 30 reflected from the light transmission and reflection mirror 20 and pass through the light splitting mirror 50.

As the light splitting mirror 50, a beam splitter may be used and the light splitting mirror 50 divides the scattered light detected from the sample 40 into two light at a same ratio.

The scattered light split as described above is moved to the detector 70, 72 through the filter 60,62 disposed on a path of light.

As the filter 60, a band-pass filter may be used, and the filter 60 is classified into a first filter 62 and a second filter 64 depending on the path of light split by the light splitting mirror 50. The first and second filters include ranges of 6.67 to 7 μm and 6.06 to 6.15 μm which are the wavelength bands passing through the light transmission and reflection mirror.

In this case, the light passing through the filter 60 is a light in which the wavelength of the light emitted from the light source 10 is removed by the light transmission and reflection mirror 20, but still includes the scattered light from the sample. Therefore, the filter 60 selectively passes through the scattered light having a wavelength band of the light source necessary to measure the degree of cure of the sample 40, that is, only the scattered lights having a wavelength associated with the measurement of the degree of cure.

More specifically, the scattered light having molecular structures participating in a curing reaction of the sample is filtered by the first filter 62 and the scattered light having molecular structures not participating in the curing reaction of the sample is filtered by the second filter 64.

The scattered light passing through the filter 60, 62 as described above moved to the detector 70 in order to detect the light intensity. As the detector 70, a CCD camera, an optical amplifier, or the like may be used, and the detector 70 may include a first detector 72 and a second detector 74 disposed on the path of light.

The first detector 72 and the second detector 74 are disposed so as to be adjacent to the first filter 62 and the second filter 64 on a path of the scattered light propagating through the light splitting mirror 50.

The light passing through the detector 70 is moved to the data acquisition unit 80 in order to collect the intensity of the detected scattered light.

The data acquisition unit 80 compares light intensities filtered by the first filter 62 and the second filter 64, that is, the light participating in the curing reaction of the sample and the light not participating in the curing reaction of the sample with each other.

When being connected to the computer, the compared data is processed in a computer 90 and the measured degree of cure is displayed.

The procedure of the degree of cure according to the exemplary embodiment of the present invention configured as described above will be described in detail below.

When the light is emitted from the light source 10, the light is traveled to the light transmission and reflection mirror 20 and is propagated to the focus lens 30.

The focus lens 30 installed in a light propagating direction of the light transmission and reflection mirror 20 determines the depth of focus of the light passing through the light transmission and reflection mirror 20. In this case, the focus lens 30 may have 40 to 100 magnifications and the focus lens 30 having an aberration greater than 0.5 may be used.

The light passing through the focus lens 30 is collided with the surface of the sample 40 and is reflected as the scattered light. The scattered light passes through the focus lens 30 again and is moved to the light transmission and reflection mirror 20. In this case, an intrinsic wavelength of the light source of the scattered light propagated to the light transmission and reflection mirror 20 transmits the light transmission and reflection mirror 20 and the scattered light is reflected and propagated.

The scattered light moved to the light transmission and reflection mirror 20 as described above is split and propagated at a ratio of 50 to 50 by the light splitting mirror 50.

While the scattered light split by the light splitting mirror 50 passes through the first filter 62 and the second filter 64, respectively, only the wavelength band necessary to measure the degree of cure passes through the filter.

The first detector 72 and the second detector 74 detect the data associated with the cure of the surface of the sample 40 from the scattered light passing through the filter 60 by the first detector 72 and the second detector 74 and the detected information is transmitted to the data obtaining unit 80.

The data obtaining unit 80 transmits and displays the cure data of the sample 40 detected as described above to the computer 90.

Therefore, the degree of cure of the sample 40 may be rapidly and accurately calculated while being non-destructive.

Particularly, since the measurement device of the degree of cure 100 according to the exemplary embodiment of the present invention is manufactured by relatively simple components, it may be easily portable in the production field and the data may be rapidly calculated.

According to the exemplary embodiment of the present invention, the measurement device of the degree of cure may directly perform the measurement of the degree of cure of the product in the production line, thereby making it possible to increase workability.

In addition, the portability is increased by a miniaturized structure, thereby making it possible contribute to production efficiency improvement.

Although the measurement device of the degree of cure according to the exemplary embodiments of the present invention has been described, the present invention is not limited thereto, but those skilled in the art will appreciate that various applications and modifications are possible.

1. A measurement device of a degree of cure, comprising:
a light source;
a light transmission and reflection mirror passing through a light irradiated from the light source and reflecting scattered light reflected and returned from a sample;
a focus lens installed between the light transmission and reflection mirror and the sample;
a light splitting mirror transmitting and reflecting the scattered light so as to detect intensity of the scattered light reflected by the light transmission and reflection mirror;
a detector detecting the intensity of the scattered light transmitted and reflected by the light splitting mirror; and
a data obtaining unit collecting data of the intensity of the scattered light detected by the detector.

2. The measurement device of the degree of cure according to claim 1, wherein the light transmission and reflection mirror is a dichroic mirror reflecting a light having a wavelength of a predetermined range and transmitting the rest of the light.

3. The measurement device of the degree of cure according to claim 1, wherein the light splitting mirror is a beam splitter.

4. The measurement device of the degree of cure according to claim 1, further comprising a focus lens installed between the light transmission and reflection mirror and the sample.

5. The measurement device of the degree of cure according to claim 1, further comprising a filter installed between the light splitting mirror and the detector.

6. The measurement device of the degree of cure according to claim 5, wherein the filter is a band-pass filter.

7. The measurement device of the degree of cure according to claim 1, wherein the detector is configured of a first detector and a second detector according to a direction of the light transmitted and reflected by the light splitting mirror.

8. The measurement device of the degree of cure according to claim 1, wherein the filter is configured of a first filter and a second filter according to a direction of the light split by the light splitting mirror.

9. The measurement device of the degree of cure according to claim 8, wherein the first filter and the second filter each filter a light wavelength having molecular structures participating in a curing reaction of the sample and a light wavelength having molecular structures not participating in the curing reaction of the sample.

10. The measurement device of the degree of cure according to claim 5, wherein the filter is configured of a first filter and a second filter according to a direction of the light split by the light splitting mirror.
